(19) United States
(12) Patent Application Publication
(10) Pub. No.: US 2022/0250724 A1
(43) Pub. Date: Aug. 11, 2022

(54) Drive Through Boat Wash With Salt Removal System

(71) Applicant: Chris Roberts, Bartow, FL (US)

(72) Inventor: Chris Roberts, Bartow, FL (US)

(21) Appl. No.: 17/578,429

(22) Filed: Jan. 18, 2022

Related U.S. Application Data
(60) Provisional application No. 63/138,358, filed on Jan. 15, 2021.

(51) Int. Cl. B63B 59/00; B60S 3/04; B60S 3/00; B08B 3/02; B08B 1/00; B08B 1/02

(52) U.S. Cl. CPC B63B 59/00; B60S 3/04; B08B 1/02; B08B 3/022; B08B 1/002; B60S 3/002

(57) ABSTRACT

A drive through boat wash with salt removal system design to wash and apply a salt removal compound to a vehicle or vehicle trailering a boat, where the boat wash is constructed to accommodate vehicles that are oversize in height, width or length.

### RELATED APPLICATIONS

This application claims the benefit of U.S. Provisional Application No. 63/138,358, filed on Jan. 15, 2021, and entitled “Drive Through Boat Wash With Salt Removal System,” which is incorporated herein by reference in its entirety.

### FIELD

Some implementations relate generally to a boat wash, and, more particularly, to a drive through boat wash with salt removal system.

### BACKGROUND

Usually after a day out on the salt water a boat owner may go home and rinse off the boat off with fresh water or maybe even apply some type of cleaning detergent. In some cases, after washing with the cleaning detergent the boat owner may apply a salt removal compound such as Salt-away. Salt-away is a water-based, biodegradable solution that is safe for use on any metal, aluminum, fiberglass, paint, rubber, plastic, chrome and glass. Salt-away contains properties that dissolve, release and remove salt crystals from any surface. Water alone may not remove all the salt from a surface.

A conventional drive through car wash or a do it yourself type car wash may only offer different types of cleaning detergents and waxes that a user can chose from. Also, a conventional drive through car wash may only accommodate a vehicle with a height up to 96 inches and a width of 100 inches and a length of 26 ft.

Embodiments were conceived in light of the above-mentioned problems and limitations, among other things.

### SUMMARY

Some implementations can include a drive through boat wash with salt removal system having a first section having a plurality of spray nozzles, a plurality of cleaning bristles, and a first collection tank, where the first section is constructed to perform a wash, and a second section having a plurality of spray nozzles, and a second collection tank, wherein the second section is constructed to apply a corrosion protection compound. In some implementations, the first section includes a plurality of blowers.

Some implementations can include a drive through boat wash with salt removal system having a housing having a plurality of spray nozzles, a plurality of cleaning bristles, and a collection tank, wherein the housing is configured to automatically perform a washing process then apply a corrosion protection compound.

In some implementations, the drive through boat wash with salt removal system is configured to perform a blow-drying process after the washing process but before the corrosion protection compound is applied.

Some implementations can include a self-serve boat wash with salt removal system including a housing having a control panel and a handheld spray nozzle, wherein the control panel includes a process selector, and wherein a user can select to apply a corrosion protection compound.

Some implementations can include a method. The method can include receiving, at a drive through boat wash or a self-service wash station, a selection of one or more operations to perform, wherein the one or more operations include application of a salt removal compound, and applying, via the drive through boat wash or the self-service wash station, the salt removal compound to at least one of a vehicle or a trailered boat in response to the selection of the one or more operations to perform.

The method can also include washing at least one of the vehicle or trailered boat in response to the selection and drying at least one of the vehicle or trailered boat in response to the selection. In some implementations, applying the salt removal compound to at least one of the vehicle or the trailered boat in response to the selection includes applying the salt removal compound to the vehicle or a boat and trailer individually, or to both the vehicle, and boat and trailer simultaneously in response to the selection.

The method can further include washing at least one of the vehicle and, boat and trailer; and drying at least one of the vehicle and, the boat and trailer.

In some implementations, the selection of one or more operations to perform includes one of: applying only salt removal compound; washing and applying salt removal compound; only washing and drying; only drying; only washing; drying and applying salt removal compound application; or washing, drying and applying salt removal compound application.

In some implementations, the washing, drying, and applying salt removal compound are performed in a single section of a drive through boat wash.

In some implementations, the washing, drying, and applying salt removal compound are performed in two or more separate sections of a drive through boat wash.

In some implementations, the washing, drying, and applying salt removal compound are performed as separate operations.

In some implementations, the washing, drying, and applying salt removal compound are performed as a single operation. The method can also include leaving the salt removal compound on the vehicle or the boat and trailer without being rinsed off or blown dry with one or more blowers. The method can further include rinsing the salt removal compound from the vehicle or the boat and trailer. The method can also include blowing the vehicle or the boat and trailer dry with blowers.

### BRIEF DESCRIPTION OF THE DRAWINGS

FIG. 1 is a diagram showing a side view of a vehicle and trailered boat entering an example drive through boat wash with salt removal system in accordance with some implementations.

FIG. 2 is a diagram showing a side view of an example drive through boat wash with salt removal system during the boat washing process in accordance with some implementations.

FIG. 3 is a diagram showing a side view of an example drive through boat wash with salt removal system during drying process in accordance with some implementations.

FIG. 4 is a diagram showing a side view of an example drive through boat wash with salt removal system during the salt removal process a in accordance with some implementations.

FIG. 5 is a diagram showing a top perspective view of the floor of an example drive through boat wash with salt removal system in accordance with some implementations.

FIG. 6 is a diagram showing a side view of an example self-serve boat wash with salt removal system in accordance with some implementations.

### DETAILED DESCRIPTION

Some implementations can include a drive through boat wash with salt removal system constructed to accommodate vehicles that are oversize in height, width or length (e.g., a long boat with a wide axle trailer or a boat with a tall tower). In some implementations, the drive through boat wash with salt removal system is configured to wash, dry, then apply a salt removal compound (e.g., Salt-Away) or other corrosion protection compound to a vehicle or a boat and trailer individually, or to both the vehicle, and boat and trailer simultaneously, depending on the user's selection. In some implementations, the drive through boat wash with salt removal system is configured to perform one or more of: 1) washing the vehicle and/or the boat and trailer, 2) drying the vehicle and/or the boat and trailer, and 3) applying a salt removal compound (e.g., Salt-Away) to the vehicle and/or the boat and trailer. For example, the drive through boat wash may be configured with one or more user selectable options such as: 1) only salt removal compound application, 2) washing and salt removal compound application, 3) only washing and drying, 4) only drying, 5) only washing, 6) drying and salt removal compound application, or 7) washing, drying and salt removal compound application. In some implementations, the washing, drying, and salt removal compound application can be performed in a single section of the drive through boat wash, or performed in two or more separate sections of the drive through boat wash. In some implementations, the washing, drying, and salt removal compound application can be performed as separate operations or can be performed as part of a single operation. In some implementations, the salt removal compound is left on the vehicle and/or the boat and trailer without being rinsed off or blown dry with the blowers. In some implementations, the salt removal compound on the vehicle and/or the boat and trailer may be rinsed off or blown dry with the blowers.

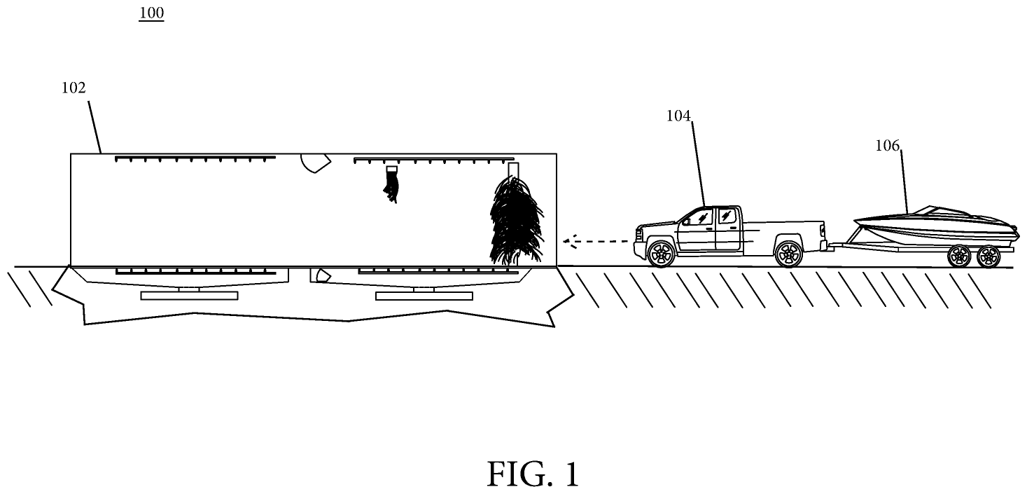

FIG. 1 is a diagram showing a side view of a vehicle and trailered boat entering an example drive through boat wash with salt removal system in accordance with some implementations. The drive through boat wash with salt removal system 100 includes a drive through boat wash with salt removal system 102, a vehicle 104, and a trailered boat 106.

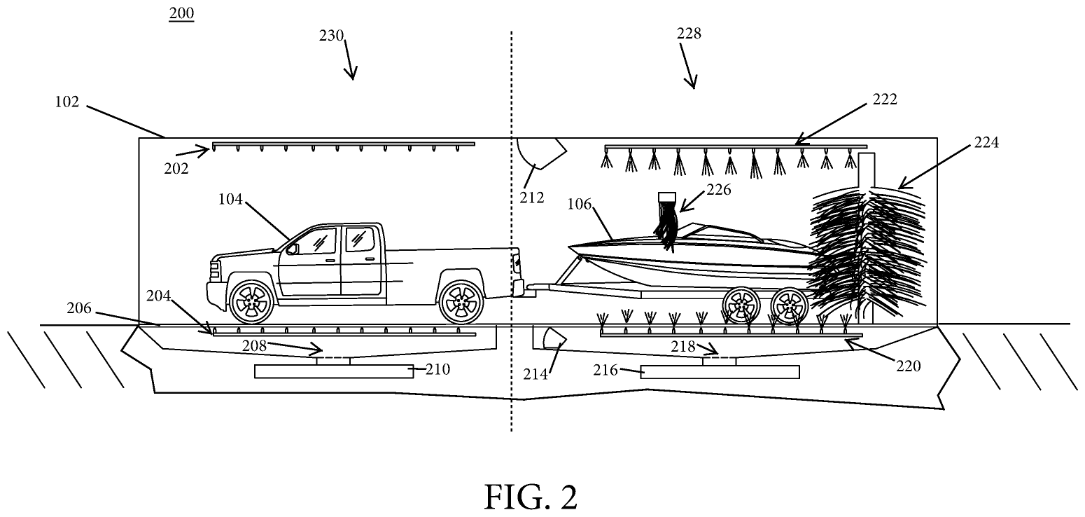

FIG. 2 is a diagram showing a side view of an example drive through boat wash with salt removal system during the boat washing process in accordance with some implementations. The diagram 200 includes the drive through boat wash with salt removal system 102, the vehicle 104, the trailered boat 106, a first section 228, a first top plurality of spray nozzles 222, a first bottom plurality of spray nozzles 220, a top plurality of cleaning bristles 226, a side plurality of cleaning bristles 224, a plurality of top blowers 212, a plurality of bottom blowers 214, a first drain 218, a first collection tank 216, a second section 230, a second top plurality of spray nozzles 202, a second bottom plurality of spray nozzles 204, a second drain 208, a second collection tank 210, and a perforated floor 206.

In some implementations, the first section 228 is configured to perform washing and/or drying, and the second section 230 is configured to apply the salt removal compound. Separating the washing process from the salt removal compound application process can permit runoff salt removal compound to be captured and reused. For example, in some implementations, the second collection tank 210 in the second section 230 is configured to receive runoff salt removal compound and store the runoff salt removal compound separately from the other fluids in the drive through boat wash (e.g., detergents or waxes) so that the runoff salt removal compound may be reused (e.g., with or without processing of the runoff salt removal compound prior to reuse).

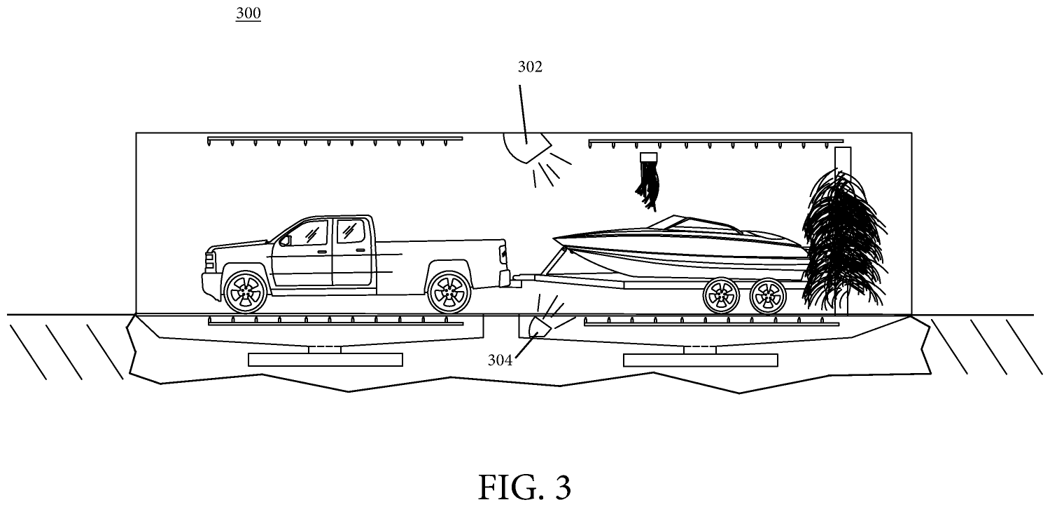

FIG. 3 is a diagram showing a side view of an example drive through boat wash with salt removal system during drying process in accordance with some implementations. The diagram 300 shows a plurality of top blowers 302 and a plurality of bottom blowers 304 in a on position.

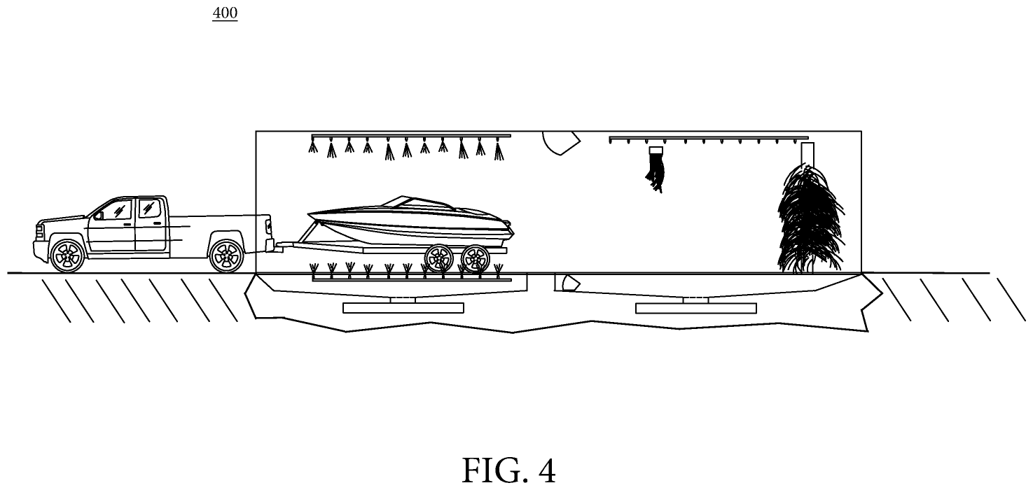

FIG. 4 is a diagram showing a side view of an example drive through boat wash with salt removal system during the salt removal process in accordance with some implementations. The diagram 400 shows a second top plurality of spray nozzles 202 and a second bottom plurality of spray nozzles 204 in the on position.

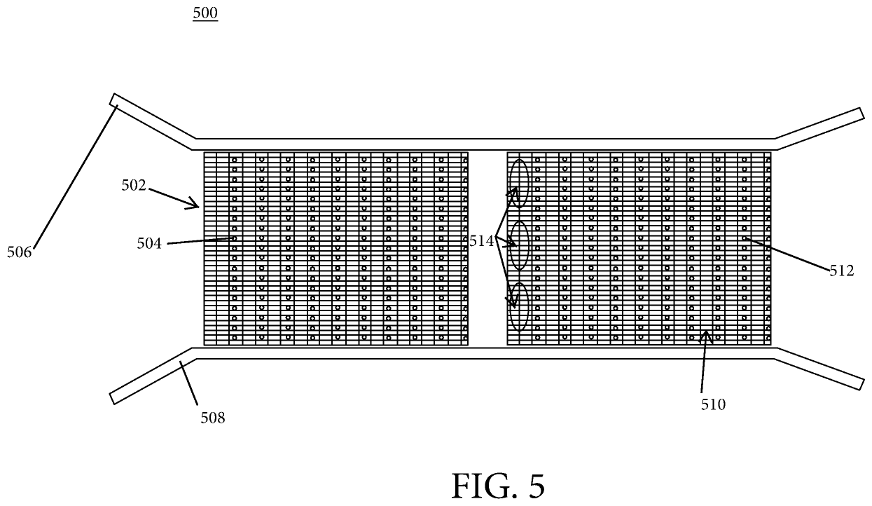

FIG. 5 is a diagram showing a top perspective view of the floor of an example drive through boat wash with salt removal system in accordance with some implementations. The diagram 500 shows a perforated floor 502, a first bottom plurality of spray nozzles 512, a second bottom plurality of spray nozzles 504, a first guide rail, a second guide rail, and a plurality of bottom blowers 514.

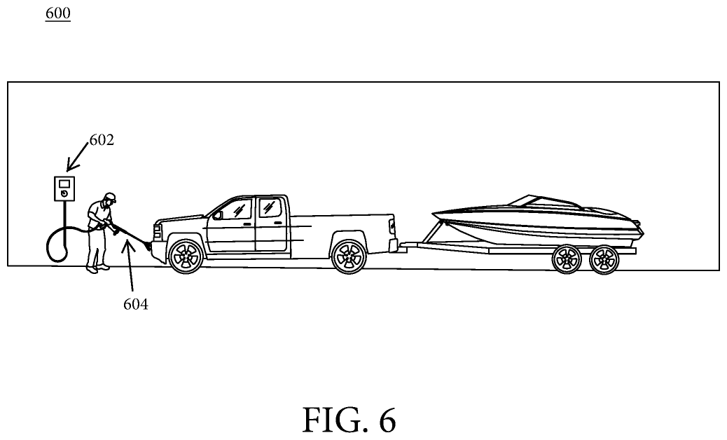

FIG. 6 is a diagram showing a side view of an example self-serve boat wash with salt removal system in accordance with some implementations. The diagram 600 shows a control panel 602, and a handheld spray nozzle 604.

A user can select to perform a wash then select to apply a protective substance (e.g., a salt removal solution) via the control panel 602.

While some implementations have been described in terms of a general embodiment with several specific modifications, it is recognized that persons skilled in this art will readily perceive many other modifications and variations of the embodiments described above within the spirit and scope of the disclosed subject matter. Applicants intend to embrace any and all such modifications, variations and embodiments.

What is claimed is:

1. A drive through boat wash with salt removal system comprising:
a first section having a plurality of spray nozzles, a plurality of cleaning bristles, and a first collection tank, wherein the first section is constructed to perform a wash; and
a second section having a plurality of spray nozzles, and a second collection tank, wherein the second section is constructed to apply a corrosion protection compound.

2. The drive through boat wash with salt removal system of claim 1, wherein at least one of the first section and the second section includes a plurality of blowers.

3. A drive through boat wash with salt removal system comprising:
a housing having a plurality of spray nozzles, a plurality of cleaning bristles, and a collection tank, wherein the housing is configured to automatically perform a washing process then apply a corrosion protection compound.

4. The drive through boat wash with salt removal system of claim 3, wherein the drive through boat wash with salt removal system is configured to perform a blow-drying process after the washing process but before the corrosion protection compound is applied.

5. A self-serve boat wash with salt removal system comprising:
a housing having a control panel and a handheld spray nozzle, wherein the control panel includes a process selector, and wherein a user can select to apply a corrosion protection compound.

6. A method comprising:
receiving, at a drive through boat wash or a self-service wash station, a selection of one or more operations to perform, wherein the one or more operations include application of a salt removal compound; and
applying, via the drive through boat wash or the self-service wash station, the salt removal compound to at least one of a vehicle or a trailered boat in response to the selection of the one or more operations to perform.

7. The method of claim 6, further comprising:
washing at least one of the vehicle or trailered boat in response to the selection; and
drying at least one of the vehicle or trailered boat in response to the selection.

8. The method of claim 6, wherein applying the salt removal compound to at least one of the vehicle or the trailered boat in response to the selection includes applying the salt removal compound to the vehicle or a boat and trailer individually, or to both the vehicle, and boat and trailer simultaneously in response to the selection.

9. The method of claim 6, further comprising:
washing at least one of the vehicle and, boat and trailer; and
drying at least one of the vehicle and, the boat and trailer.

10. The method of claim 6, wherein the selection of one or more operations to perform includes one of: applying only salt removal compound; washing and applying salt removal compound; only washing and drying; only drying; only washing; drying and applying salt removal compound application; or washing, drying and applying salt removal compound application.

11. The method of claim 10, wherein the washing, drying, and applying salt removal compound are performed in a single section of a drive through boat wash.

12. The method of claim 10, wherein the washing, drying, and applying salt removal compound are performed in two or more separate sections of a drive through boat wash.

13. The method of claim 10, wherein the washing, drying, and applying salt removal compound are performed as separate operations.

14. The method of claim 10, wherein the washing, drying, and applying salt removal compound are performed as a single operation.

15. The method of claim 6, further comprising leaving the salt removal compound on the vehicle or the boat and trailer without being rinsed off or blown dry with one or more blowers.

16. The method of claim 6, further comprising rinsing the salt removal compound from the vehicle or the boat and trailer.

17. The method of claim 6, further comprising blowing the vehicle or the boat and trailer dry with blowers.
